(19) United States
(12) Patent Application Publication
(10) Pub. No.: US 2010/0175037 A1
(43) Pub. Date: Jul. 8, 2010

(54) METHOD, APPARATUS, AND PROGRAM FOR CORRECTING HOLD ERROR

(75) Inventors: Ryo MIZUTANI, Kawasaki (JP); Seiji SHIGIHARA, Kawasaki (JP); Michitaka HASHIMOTO, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/652,196

(22) Filed: Jan. 5, 2010

(30) Foreign Application Priority Data
Jan. 6, 2009 (JP) 2009-1130

(51) Int. Cl. G06F 17/50

(52) U.S. Cl. 716/6

(57) ABSTRACT

A hold error correction method for complicated large scale integration in a semiconductor is provided. Based on timing analyses, hold error path start point information including a set of a hold error amount at a start point and a minimum value in set-up margins for all data paths starting from the start point, and hold error path end point information including a set of a hold error amount at an end point and a minimum value in set-up margins for all data paths reaching the end point, in association with a failed hold error path, is obtained. The hold error path is classified based on whether the hold error is correctable according to the obtained information. The correctable hold error path is grouped based on a certain criterion. Finally, which of the start point and the end point a delay buffer is inserted into is determined per group.

### CROSS-REFERENCE TO RELATED APPLICATIONS

This application is based upon and claims the benefit of priority of the prior Japanese Patent Application No. 2009-001130, filed on Jan. 6, 2009, the entire contents of which are incorporated herein by reference.

### FIELD

The disclosed embodiments relate to a method, an apparatus, and a program for correcting a hold error in a semiconductor integrated circuit.

### BACKGROUND

As methods of correcting hold errors (hereinafter, may be referred to as a “hold error correction method”) in semiconductor integrated circuits, such as, a large scale integration (LSI) or the like, it has been know that a search for a position on a data path, on which a delay buffer is to be inserted (hereinafter, may be referred to as a “delay buffer insertion position”), is performed while taking an amount of hold errors and values for set-up margins into account with respect to all circuit elements on the data paths.

FIG. 1 illustrates a flowchart explaining a conventional hold error correction method.

An analysis of hold timing (hereinafter, may be referred to as a “hold timing analysis”) is performed, in Operation S101. In addition, an analysis of set-up timing (hereinafter, may be referred to as a “set-up timing analysis”) is performed, in Operation S102. When a logic circuit is used in an integrated circuit, such timing analyses are performed in order to determine whether or not there is a violation of a timing constraint, which is defined based on inputs from a D flip-flop or the like, by using values obtained from a result of accumulation of propagation delay times incurred on paths in the logic circuit. The hold timing analysis is performed to specify a start point and an end point of a path. Furthermore, when a hold error has occurred, a hold error value may be specified by performing the hold timing analysis. The set-up timing analysis is performed to specify a start point and an end point of a path. Moreover, a value for a set-up margin (hereinafter, may be referred to as a “set-up margin value”), which represents a degree of margin relative to a set-up constraint, may be specified by performing the set-up timing analysis. As a result of such analyses, a set of the start points, a set of the end points, a set of the hold error values at the start point or the end point, and a set of the set-up margin values at the start point or the end point are composed with respect to each of the paths in Operation S103.

In Operation S104, extraction of a path on which a hold error has occurred (hereinafter, may be referred to as a “hold error path”) is performed from the sets of values with respect to each of the paths. In Operation S105, a search for a preferred delay buffer insertion position to remedy a hold error violation is performed on the extracted path. As detailed techniques of searching for the delay buffer insertion position, the following methods have been discussed. For example, a data path is traced from a start point or from an end point. Furthermore, for example, priority is placed on circuit elements on the data paths by applying evaluation functions to such circuit elements.

However, since the searches for the delay buffer insertion positions are performed on all of the hold error paths in the conventional method discussed above, it is necessary that the searches are performed on all of the circuit elements on the data paths in order to determine whether a certain path is a path whose hold error is uncorrectable (hereinafter, may be referred to as an “uncorrectable hold error path”) or not. For this reason, along with an increase in data paths on the semiconductor integrated circuit resulted from increased large scale integration and increased complexity, the conventional methods discussed above need a huge amount of processing time to obtain solutions due to an explosive increase in searches for the preferred delay buffer insertion positions. Because of the problem discussed above, the conventional methods are no longer practical.

The disclosed embodiments has been made to address the problem discussed above, and it is an aspect of the disclosed embodiments to provide a method of correcting a hold error, an apparatus for correcting the hold error, and a program for correcting the hold error, all of which are applicable to a semiconductor integrated circuit with increased large scale integration and with increased complexity.

### SUMMARY

According to an aspect of the disclosed embodiments, an apparatus for correcting a hold error occurring in a semiconductor integrated circuit includes an analyzing unit which performs a hold timing analysis and a set-up timing analysis to analyze whether there is a violation of a timing constraint defined in association with a set-up time and a hold time in the semiconductor integrated circuit; a hold error information acquiring unit which acquires hold error path start point information, which includes a set of a hold error amount at a start point of the hold error path and a minimum value in set-up margins for all data paths starting from the start point, and hold error path end point information, which includes a set of a hold error amount at an end point of the hold error path and a minimum value in set-up margins for all data paths reaching the end point, with respect to a hold error path on which a hold error has occurred, based on each of results obtained by the analysis unit; a classifying unit which classifies the hold error path into one of a correctable hold error path whose hold error is correctable and an uncorrectable hold error path whose hold error is uncorrectable, based on an output of the hold error information acquisition unit; a grouping unit which groups the hold error paths, classified by the classification unit as the correctable hold error paths, based on whether one of a start point and an end point of each of the correctable hold error paths coincides with each other; and a determining unit which determines into which of the start point and the end point of the correctable hold error path a delay buffer is inserted with respect to each group of the correctable hold error paths grouped by the grouping unit.

The object and advantages of the disclosed embodiments will be realized and attained by means of the elements and combinations particularly pointed out in the claims.

It is to be understood that both the foregoing general description and the following detailed description are exemplary and explanatory and are not restrictive of the disclosed embodiments, as claimed.

### BRIEF DESCRIPTION OF DRAWINGS

FIG. 1 illustrates a flowchart explaining a conventional hold error correction method;

FIG. 2 illustrates a flowchart explaining a hold error correction method according to a first embodiment;

FIG. 3 illustrates a flowchart detailing an operation of grouping hold error paths;

FIG. 4 illustrates a flowchart detailing an operation of selecting a buffer insertion position;

FIG. 5 illustrates a flowchart explaining a hold error correction method according to a second embodiment;

FIG. 6 illustrates a flowchart explaining a hold error correction method according to a third embodiment;

FIG. 7 illustrates a block diagram of a circuit which is a target of the hold error correction method according to any of the first to the third embodiments;

FIG. 8 illustrates a block diagram of a circuit into which a delay buffer is ultimately inserted by using the hold error correction method according to any of the first to the third embodiments;

FIG. 9A illustrates an example of a circuit for the purpose of comparing the hold error correction method according to any of the first to the third embodiments with the conventional hold error correction method;

FIG. 9B illustrates a circuit explaining the hold error correction methods according to any of the first to the third embodiments of the disclosed embodiments; and

FIG. 10 illustrates an example of a hardware configuration of a computer executing a program for correcting the hold error according to any of the first to the third embodiments.

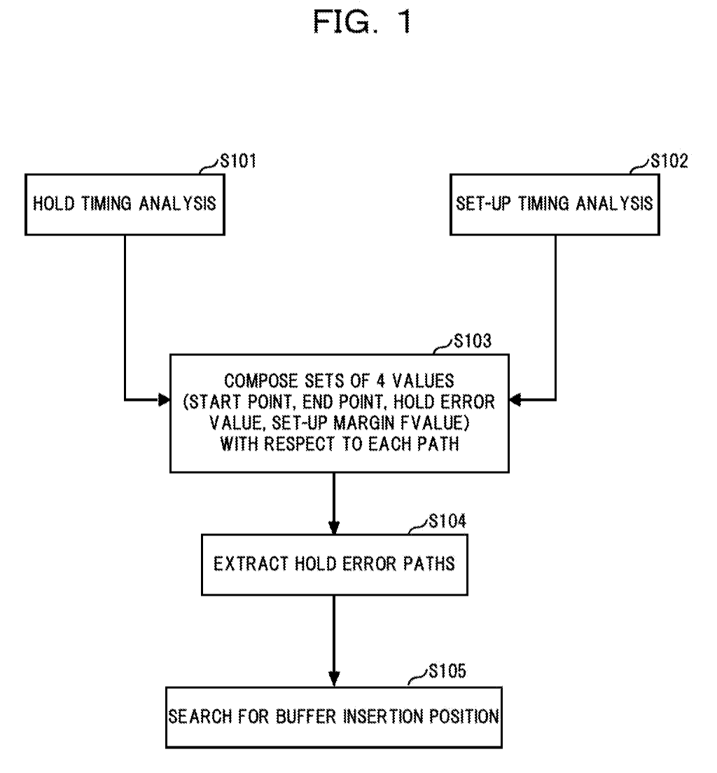

### DESCRIPTION OF EMBODIMENTS

Hereinafter, embodiments will be disclosed with reference to attached drawings.

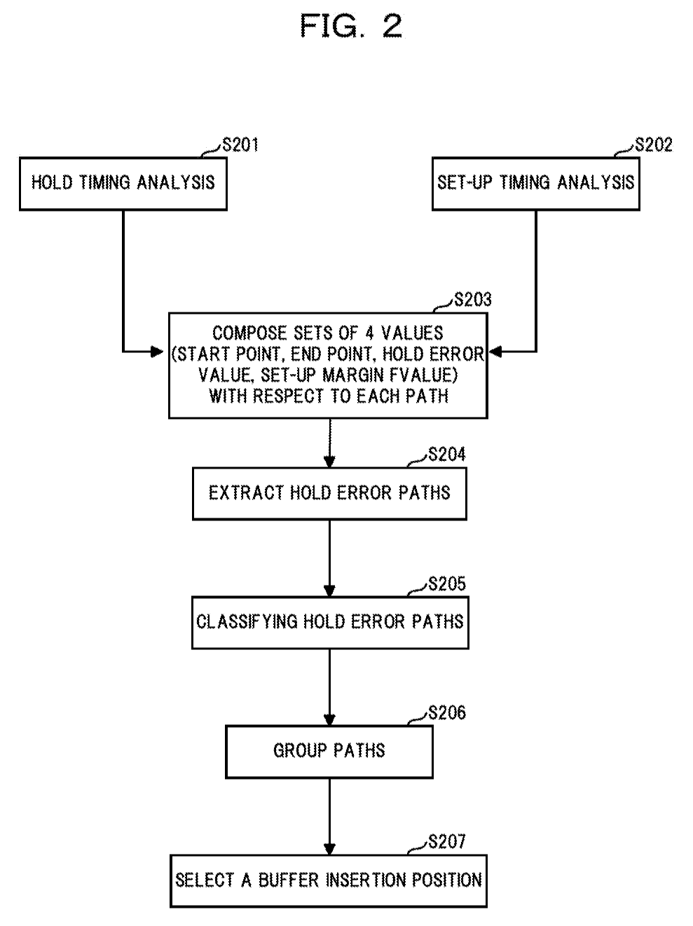

FIG. 2 illustrates a flowchart explaining a hold error correction method according to a first embodiment.

A hold timing analysis is performed in Operation S201. A set-up timing analysis is performed in Operation S202. When a logic circuit is used in an integrated circuit, these timing analyses are performed to determine whether or not there is a violation of any timing constraint, which is defined based on inputs from a D flip-flop or the like, by using values obtained from a result of accumulation of propagation delay times incurred on paths in the logic circuit. The hold timing analysis is performed to specify a start point of a path and an end point of the path. Furthermore, when a hold error has occurred, performing the hold timing analysis allows a hold error value to be obtained. The set-up timing analysis is performed to specify a start point of a path and an end point of the path. Moreover, performing the set-up timing analysis allows a set-up margin value to be obtained. The set-up margin value represents a degree of margin relative to the set-up constraint.

In Operation S203, based on results obtained by the hold timing analysis and the set-up timing analysis, information associated with the start point of each of hold error paths on which the hold errors have occurred (hereinafter, may be referred to as “hold error path start point information”) and information associated with the end point of each of the paths on which the hold errors have occurred (hereinafter may be referred to as “hold error path end point information”) are obtained. The hold error path start point information includes a set of values. One value represents an amount of hold errors at the start point of a certain hold error path. Another value represents a minimum value in set-up margins for all the data paths that start from the staring point. The hold error path end point information includes a set of values. One value represents an amount of hold errors at the end point of a certain hold error path. Another value represents a minimum value in set-up margins for all the data paths that reach the certain end point. Next, in Operation S204, the hold error path start point information and the hold error path end point information, with respect to each of the paths, are grouped together. As are result thereof, the hold error paths are extracted from all of data paths in the integrated circuit.

In Operation S205, based on certain determination criteria, the hold error path is classified into two types: the path whose hold error is correctable (hereinafter, may be referred to as a “correctable hold error path”), and an uncorrectable hold error path. Such classification may be achieved by defining an evaluation function to which the start point of the path, the end point of the path, the hold error value, and the set-up margin value are assigned.

For example, if both equations represented below are satisfied, the target hold error path is determined to be the correctable hold error path.

EQUATIONS:

“a×(start point set-up margin value)−b×(start point hold error value)>c” and “d×(end point set-up margin value)−e×(end point hold error value)>f”

Note, here, that respective coefficients a, b, c, d, e, and f are the values specified based on a required performance of a semiconductor integrated circuit. Thus, these coefficients are defined by semiconductor IC designers or technology suppliers.

Next, in Operation S206, the hold error paths determined as the correctable hold error paths are grouped to form a plurality of hold error path groups. In Operation S207, selection is made as to which of the two points, that is, the start point or the end point of the path, a delay buffer is inserted into, with respect to each of the groups thus formed. This selection allows information representing a delay buffer insertion position to be created. Note that it is desirable that the delay buffer insertion position be selected so that a minimum cost is achieved with respect to each of the groups, by preparing a cost function that is obtained by combining the number of buffers, an amount of delays, an area into which the delay buffer is inserted, consumption of power, the number of correctable hold error data paths, an amount of processes incurred by changes in layout resulting from the buffer insertion, and so on.

An amount of memory and a processing time searching for the buffer insertion positions is determined based on the information associated with the number of start points, the number of end points, and the number of inserted buffers for the data paths on which the hold errors have occurred. For this reason, the amount of memory and the processing time are dependent on the number of hold errors regardless of circuit size and complexity in the data paths. In consequence, as disclosed in the first embodiment, reduction in the amount of memory and the processing time searching for the buffer insertion positions may be achieved in comparison with the conventional method, by classifying the hold error paths, by grouping the hold error paths into groups, and by selecting the buffer insertion positions with respect to each of the groups.

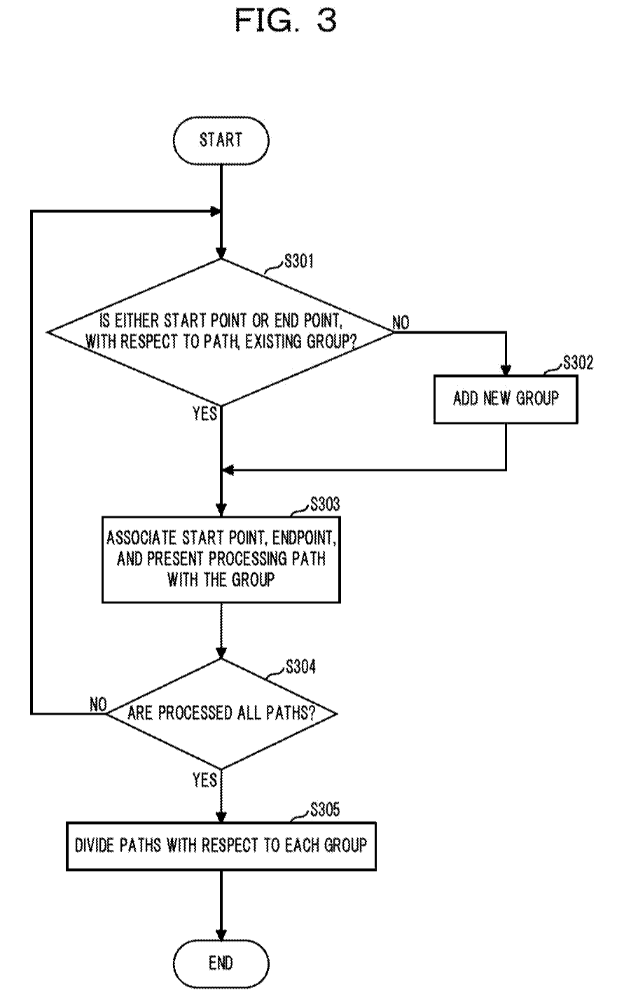

FIG. 3 illustrates a flowchart detailing an operation of grouping the hold error paths determined as correctable hold error paths (Operation S206).

First, whether or not at least either the start point or the end point of a target hold error path is shared with the start point or the end point of another hold error path that is included in an existing group is determined in Operation S301. If neither the start point nor the end point of the target hold error path is shared with the start point or the end point of another hold error path that is included in the existing group, a new group that includes the target hold error path is added in Operation S302. Thereafter, in Operation S303, the start point and the end point of the target hold error path are associated with the new group or the existing group.

Next, whether all the hold error paths determined as correctable hold error paths have been grouped or not is determined in Operation S304. Operations S301 through S303 are repeated until the grouping with respect to all the hold error paths determined as correctable hold error paths has been completed. Finally, the paths are divided with respect to each group, in Operation S305.

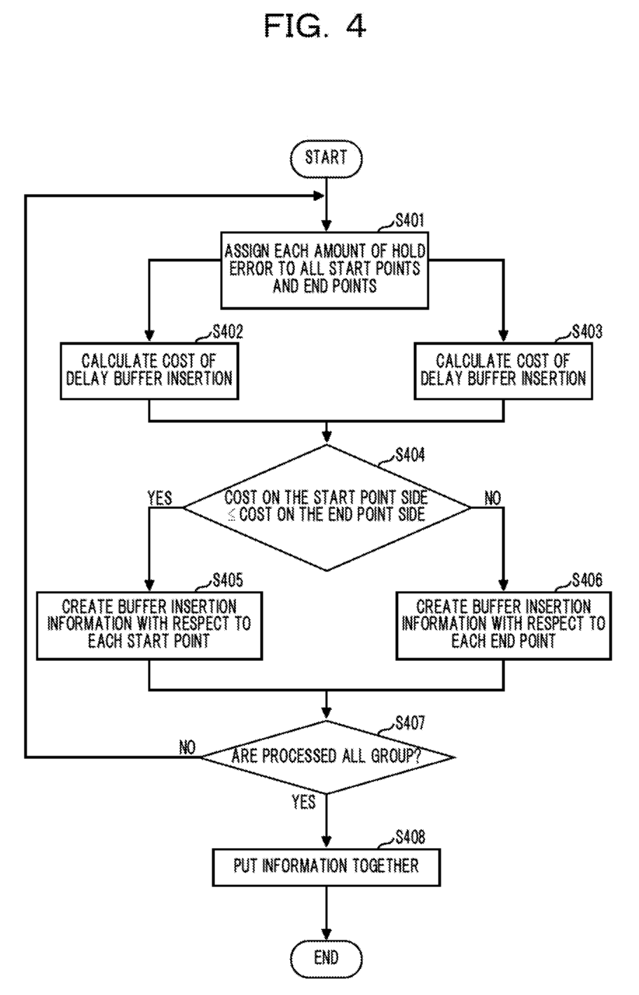

FIG. 4 illustrates a flowchart detailing an operation of selecting the buffer insertion positions with respect to each of the hold error path groups (Operation S207).

First, the amount of hold errors is assigned to the start point and the end point of respective hold error paths included in the target hold error path group, in Operation S401.

In Operation S402, the cost for inserting the delay buffer (hereinafter, may be referred to as a “delay buffer insertion cost”) is calculated with respect to the start point by using a cost function obtained by combining the number of buffers, the amount of delays, the area into which the delay buffer is inserted, the consumption of power, the number of correctable hold error data paths, the amount of processing incurred by the changes in layout resulting from the delay buffer insertion, and so on. In the same or similar manner, the delay buffer insertion cost is calculated with respect to the end point, in Operation S403.

Sum of the delay buffer insertion cost for the start points and sum of the delay buffer insertion cost for the end points are compared in Operation S404. If sum of the delay buffer insertion cost for the start points is less than that for the end points in a certain group, the delay buffers are inserted into the start points. Information that represents the number of the delay buffer insertion positions for inserting the delay buffer into the start points is created in Operation S405. On the other hand, if sum of the delay buffer insertion cost for the end points is less than that for the start points in a certain group, the delay buffer is inserted into the end points. Information that represents the number of delay buffer insertion positions for inserting the delay buffer into the end points is created in Operation S406.

Next, whether the buffer insertion positions have been selected for all the hold error path groups or not is determined in Operation S407. Then, Operations S401 through S406 are repeated until the selection of the buffer insertion positions for all the hold error path groups has been completed. Finally, the information created with respect to each of the groups is put together in Operation S408.

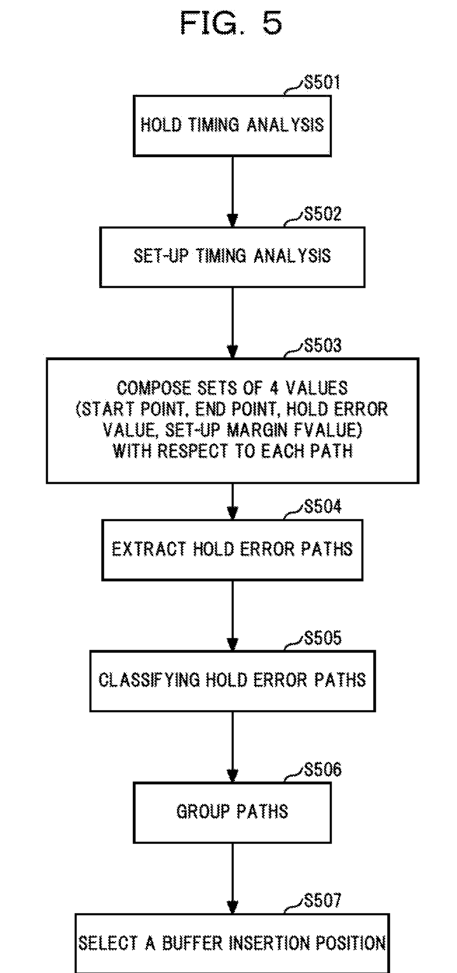

FIG. 5 illustrates a flowchart explaining a hold error correction method according to a second embodiment.

The second embodiment illustrated in FIG. 5 is different from the first embodiment explained by referring to FIG. 2 in that a set-up timing analysis is performed only on a path which shares a start point or an end point with the path on which a hold error has occurred. In Operation S501, a hold timing analysis is performed, so that the start point and the end point of a path are specified. Then, when the hold error has occurred, a hold error value is obtained. Next, the set-up timing analysis is performed only on paths sharing the start point or the end point with the path on which the hold error has occurred, in Operation S502.

In consequence, use of information associated with the start point and the end point of the path on which the hold error has occurred makes it possible to omit calculations for the set-up margins of the entire circuit in the set-up timing analyses, and thus a reduction in processing time may be achieved.

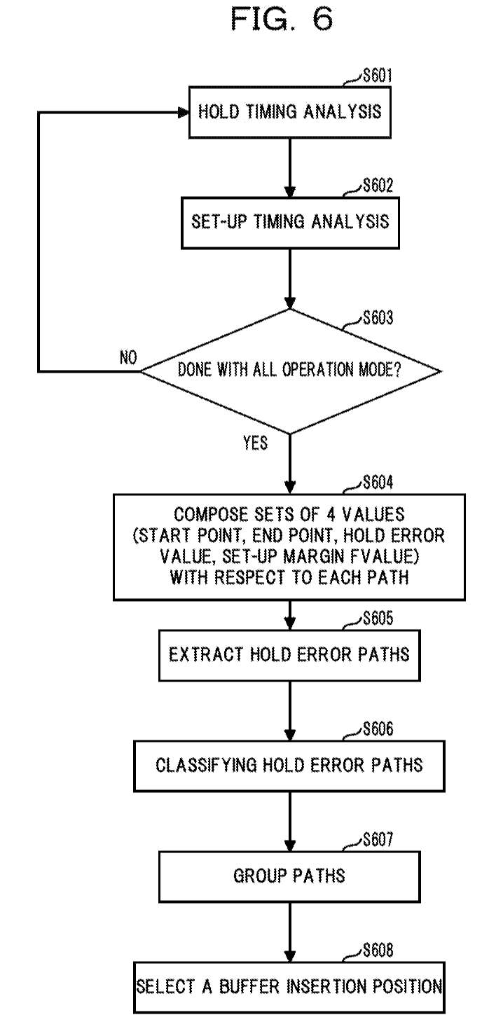

FIG. 6 illustrates a flowchart explaining a hold error correction method according to a third embodiment.

The third embodiment illustrated in FIG. 6 is different from the first embodiment explained by referring to FIG. 2 and the second embodiment explained by referring to FIG. 5 in that a hold timing analysis and a set-up timing analysis are performed in a plurality of operation modes of the integrated circuit. Based on a certain operation mode, the hold timing analysis is performed in Operation S601 and the set-up timing analysis is performed in Operation S602.

Next, whether the hold timing analysis and the set-up timing analysis have been performed with respect to all of the modes or not is determined in Operation S603. Then, Operations S601 and S602 are repeated until the hold timing analysis and the set-up timing analysis have been performed with all of the modes.

In consequence, the hold error path start point information and the hold error path end point information, associated with each hold error path on which a hold error has occurred, may be obtained with respect to each operation mode, in Operation S604. The hold error path start point information includes a set of values. One value represents an amount of hold errors at the start point of a certain hold error path. The other value represents a minimum value in set-up margins for all data paths that starts from the staring point. The hold error path end point information also includes a set of values. One value represents an amount of hold errors at the end point of a certain hold error path. The other value represents a minimum value in set-up margins for all data paths that reach the end point. In consequence, the sets of values used in subsequent processes are the values not only in consideration of the respective paths but also in consideration of all operation modes.

As disclosed above, processing for the hold error correction method according to any of the first through the third embodiments may be enhanced.

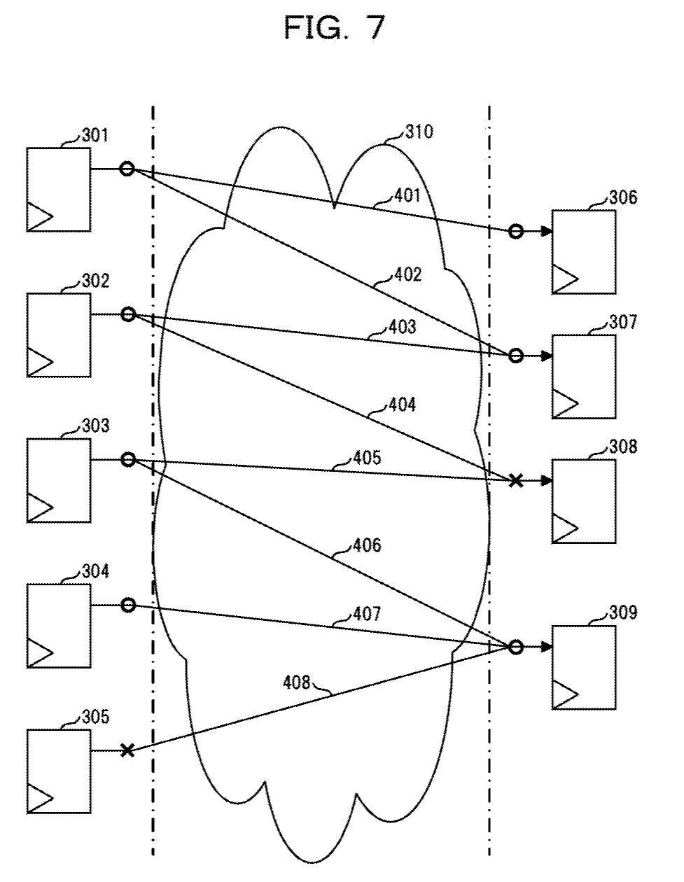

FIG. 7 illustrates a block diagram indicating a circuit which is a target of the hold error correction method, according to any of the first to the third embodiments.

Numerical references 301 through 305 in FIG. 7 represent flip-flop circuits on the start point side. Numerical references 306 through 309 represent flip-flop circuits on the end point side. A piece of data reaches any one of the flip-flop circuits 306 through 309 located on the end point side through a combinational logic circuit 310 from any one of the flip-flop circuits 301 through 305 located on the start point side.

FIG. 7 illustrates a state in which information associated with the hold error paths is created from results of the hold timing analyses and the set-up timing analyses. As a result of the hold timing analysis and the set-up timing analysis, a set of the start points, a set of the end points, the hold error value at the start point or the end point, and the set-up margin value at the start point or the end point are specified. When the delay buffer is inserted into a certain start point or a certain end point, it is possible to determine a degree of margin relative to a set-up constraint at a data path that is connected to the start point or the end point, by using these values.

For example, the hold error paths indicated by arrows 401 through 408, starting from the flip-flop circuits 301 through 305 on the start point side, and reaching the flip-flop circuits 306 through 309 on the end point side, are specified. There exist two (2) hold error paths 401 and 402 each starting from an output of the flip-flop circuit 301, as their start points, and reaching each of the flip-flop circuits 306 and 307. There exist two (2) hold error paths 403 and 404 each starting from an output of the flip-flop circuit 302, as their start points, and reaching each of the flip-flop circuits 307 and 308. There exist two (2) hold error paths 405 and 406 each starting from an output of the flip-flop circuit 303, as their start points, and reaching each of the flip-flop circuits 308 and 309. There exists one (1) hold error path 407 starting from an output of the flip-flop circuit 304, as its start point, and reaching the flip-flop circuit 309. There exists one (1) hold error path 408 starting from an output of the flip-flop circuit 305, as its start point, and reaching the flip-flop circuit 309.

Furthermore, as indicated by circle signs “o” or X signs “x” at the start points and the end points of the hold error paths in FIG. 7, when the delay buffers are inserted into a start point or end point, whether the set-up constraint is satisfied or not is determined with respect to each of the data paths. Note, here, that the circle sign “o” indicates that the set-up constraint is satisfied. On the other hand, the X sign “x” indicates that the set-up constraint is not satisfied. Based on results of the determinations, the hold error paths are each classified into either the correctable hold error path or the uncorrectable hold error path. More specifically, insertion of the delay buffer into at least either the start point or the end point allows determination that the data path which does not satisfy the set-up constraint is the uncorrectable hold error path. In the example illustrated in FIG. 7, with respect to the hold error path 408 whose start point is the output of the flip-flop circuit 305, if the delay buffer is inserted into the start point, the set-up constraint is not satisfied. In addition, with respect to at least one of the hold error paths 404 and 405 whose end points are an input of the flip-flop circuit 308, if the delay buffer is inserted into the end points, the set-up constraint is not satisfied. Consequently, the hold error path 408 whose start point is the output of the flip-flop circuit 305 and the hold error paths 404 and 405 whose end points are the input of the flip-flop circuit 308 are determined to be the uncorrectable hold error paths. On the other hand, the hold error paths except the above-described hold error paths (that is, the hold error paths 401 through 403, 406, and 407) are determined to be the correctable hold error paths.

Next, as detailed in FIG. 3, with respect to the hold error paths 401 through 403, 406, and 407 that are determined to be the correctable hold error paths, these hold error paths are classified into groups based on whether these hold error paths share the start points and/or the end points or not. For example, since the hold error paths 401 and 402 share the output of the flip-flop circuit 301, as their start points, both hold error paths 401 and 402 are determined to belong to the same group. Moreover, like the hold error path 402, since the hold error path 403 shares an input of the flip-flop circuit 307 as its end point, both hold error paths 402 and 403 are determined to belong to the same group. In this way, a first group that includes the hold error paths 401, 402, and 403 and a second group that includes the hold error paths 406 and 407 are formed.

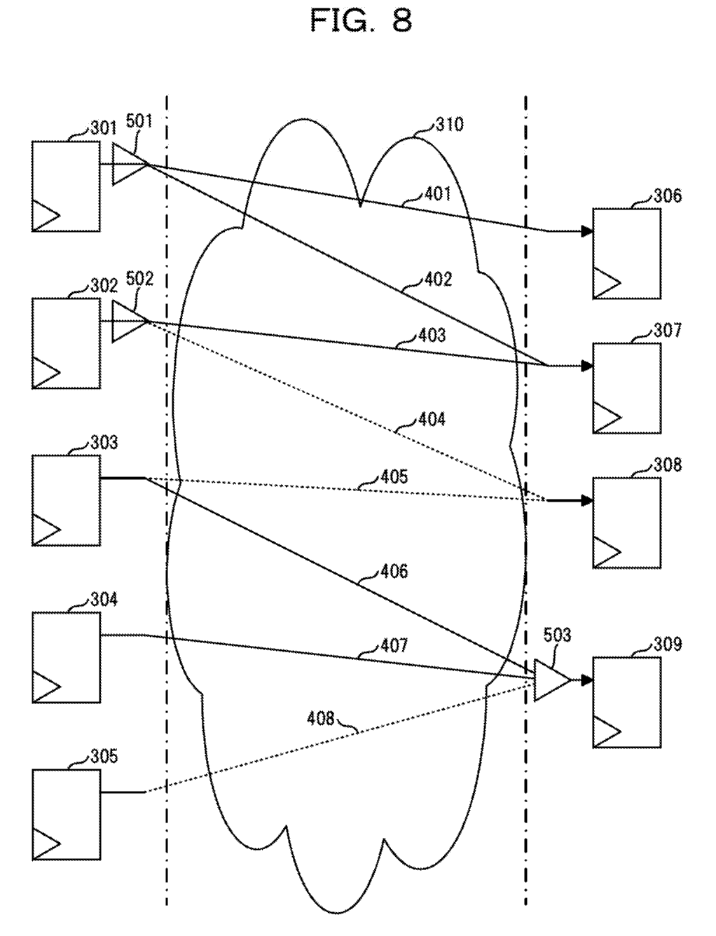

Finally, as detailed in FIG. 4, it is determined which of the two (2) points (the start point and the end point) the delay buffer is inserted into, with respect to each of the groups thus formed. For example, a calculation for the buffer insertion cost is made based on the number of buffers, and if the number thereof is the same at both points (the start point and the end point), it is possible to preferentially select the start point. FIG. 8 illustrates a block diagram of a circuit into which the delay buffers are inserted by using the hold error correction method according to any of the first to the third embodiments. In the example illustrated in FIG. 8, delay buffers 501 and 502 are inserted into the start points of the hold error paths of the first group that includes the hold error paths 401, 402, and 403. On the other hand, a delay buffer 503 is inserted into the end point of the hold error path of the second group that includes the hold error paths 406 and 407. Each of the delay buffers 501 through 503 thus inserted does not necessarily have the same characteristics. To the contrary, the delay buffers 501 through 503 may be different buffers each having an amount of delay enough to correct the hold error that occurred in each hold error path.

According to the embodiments disclosed above, a reduction in processing load may be achieved in comparison with the conventional methods because attention is paid only to the set of the start point and the end point of the data path on which the hold error occurs. In the conventional methods, to determine an appropriate amount of buffer to be inserted and an appropriate buffer insertion position, the hold error value and the set-up margin value with respect to all routes in the data paths, on which the hold errors have occurred, need to be specified. Since the amount of calculations for obtaining the amount of memory and selecting the delay buffer insertion position necessary for holding the values are dependent on the circuit size, the amount of calculations result in an increase in processing load in the large scale integration.

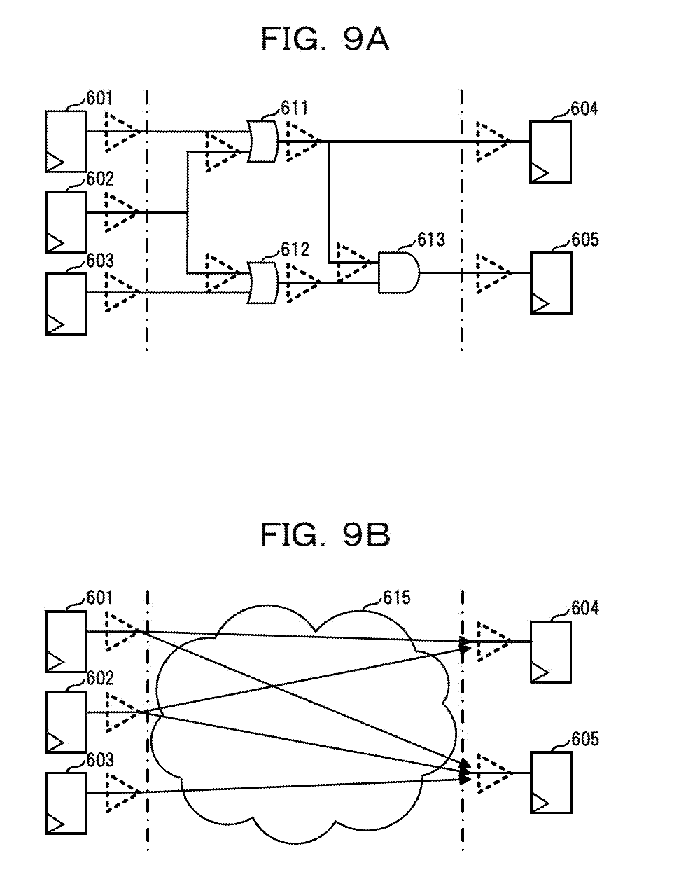

FIGS. 9A and 9B illustrate examples of circuits to compare the hold error correction methods according to any of the first to the third embodiments with the conventional methods. FIG. 9A illustrates a circuit explaining the conventional methods, and FIG. 9B illustrates a circuit explaining the hold error correction methods according to any of the first to the third embodiments of the disclosed embodiments.

The example of the circuit illustrated in FIG. 9A is provided with flip-flop circuits 601 through 603 on the start point side and flip-flop circuits 604 and 605 on the end point side. Data output from the flip-flop circuit 601 is transferred to the flip-flop circuit 604 through a logic circuit 611 and further transferred to the flip-flop circuit 605 through a logic circuit 613. Data output from the flip-flop circuit 602 is transferred to the flip-flop circuit 604 through the logic circuit 611 and further transferred to the flip-flop circuit 605 through the logic circuit 613 or not through the logic circuit 611 but through a logic circuit 612 and the logic circuit 613. Data output from the flip-flop circuit 603 is transferred to the flip-flop circuit 605 through logic circuits 612 and 613. In the conventional methods, it is necessary to know details on how the electrical connections are made in the circuit as a whole. According to the methods disclosed in any of the first to the third embodiments of the disclosed embodiments, however, as illustrated in FIG. 9B, it is not necessary to know details on how the electrical connections of a combinational logic circuit 615 provided between the flip-flop circuits are made.

In addition, in the conventional methods, it is necessary to hold data associated with the hold error values and the set-up margin values, for example, with respect to ten (10) nodes (illustrated as dotted triangles) in the circuit example illustrated in FIG. 9A. Moreover, to search for an appropriate buffer insertion position, it is necessary to perform a process selecting one out of “2¹⁰⁻¹ (that is, two to the power of ten minus one)” combinations. However, according to the methods in any of the first to the third embodiments of the disclosed embodiments, it is enough to hold the details of the electrical connections associated with five (5) flip-flop circuits and data associated with five (5) nodes (each of the outputs of the flip-flop circuits 601 through 603 and each of the inputs of the flip-flop circuits 604 and 605). Consequently, approximately a half amount of memory use is enough for the method according to any of the first to the third embodiments of the disclosed embodiments in comparison with the conventional methods in the circuit example illustrated in FIG. 9A. Furthermore, the search for the buffer insertion position is achieved based on a choice from two (2) ways: the choice from the start point side of the data path and the choice from the end point side thereof.

The more complicated the circuit becomes, the more advantageous the effect obtained from any of the first to the third embodiments becomes. To compare the amount of calculations, a circuit that includes a two-input combinational logic circuit will be mentioned as a complicated example. In this circuit, the number of flip-flop circuits is one hundred (100) and all the data paths have three (3) stages. In such a circuit, data input to one (1) of the flip-flop circuits provided on the end point side is sent from any one of eight (8) flip-flop circuits provided on the start point side. That is to say, when one (1) flip-flop circuit on the end point side receives the data from one (1) of the eight (8) flip-flop circuits on the start point side, there are eight (8) data paths through which the data is transferred. In consequence, the number of data paths is approximately eight hundred (800), and the number of nodes is equal to or more than one thousand and five hundred (1500). If hold errors have occurred on all the data paths, it is necessary, in the conventional method, to set flags indicating determination results of insertion/non-insertion of the buffers to all 1500 nodes. However, according to the method in any of the first to the third embodiments of the disclosed embodiments, it is enough to set the flags to at most one hundred (100) nodes, in response to results of selecting the start points or the end points.

That is not to say that no conventional hold error correction method exists in which the correction is performed only by paying attention to the start point and the end point. However, since each of the data paths on which the hold errors have occurred are handled in sequence, the method according to the conventional technique may make it very difficult to effectively improve the amount of delay buffers to be inserted regarding the circuit as a whole. For example, regarding the circuit illustrated in FIGS. 7 and 8, the number of delay buffers to be inserted into the entire circuit is three (3) according to the methods in any of the first to the third embodiments of the disclosed embodiments. However, since the method according to the conventional technique handles the hold error paths in sequence, the delay buffers are inserted into the nodes on the sides of the data paths. However, the set-up margin may also be satisfied only by inserting the delay buffer into the node on the data path side. That is to say, the number of delay buffers inserted into the circuit as a whole is four (4), and thus, the number of delay buffers used in the conventional method is greater than that used in any of the first to the third embodiments of the disclosed embodiments. In this way, according to the methods in any of the first to the third embodiments of the disclosed embodiments, not only correction of the hold errors but also an effective reduction in the increase in the circuit size may be achieved. In other words, according to any of the first to the third embodiments disclosed above, an effective improvement of the amount of delay buffers to be inserted into the circuit as a whole may be achieved. This effective improvement may be achieved by classifying the hold error paths based on whether the hold error is correctable or not, by grouping them with respect to each type of the hold error paths, and by performing the selection so that the buffer is inserted into either the start point or the end point with respect to each path group.

In addition, as another hold error correction method according to the conventional techniques, there is a method in which a clock of a flip-flop circuit on the start point side is delayed or a clock of a flip-flop on the end point side is advanced, by correcting a clock tree. In this conventional method, however, it is necessary to hold the hold error values and the set-up margin values at the start point and at the end point of the data path on which the hold error has occurred. In addition thereto, it is also necessary to hold the values of the data paths previous to and subsequent to the above-mentioned data path. In consequence, the amount of memory necessary for this conventional method is, at maximum, three (3) times as much as that used in the methods according to the first to the third embodiments of the disclosed embodiments. Thus, this method according to the conventional technique is disadvantageous.

The hold error correction method according to any of the first to the third embodiments may be achieved as a program executable by being installed on a computer.

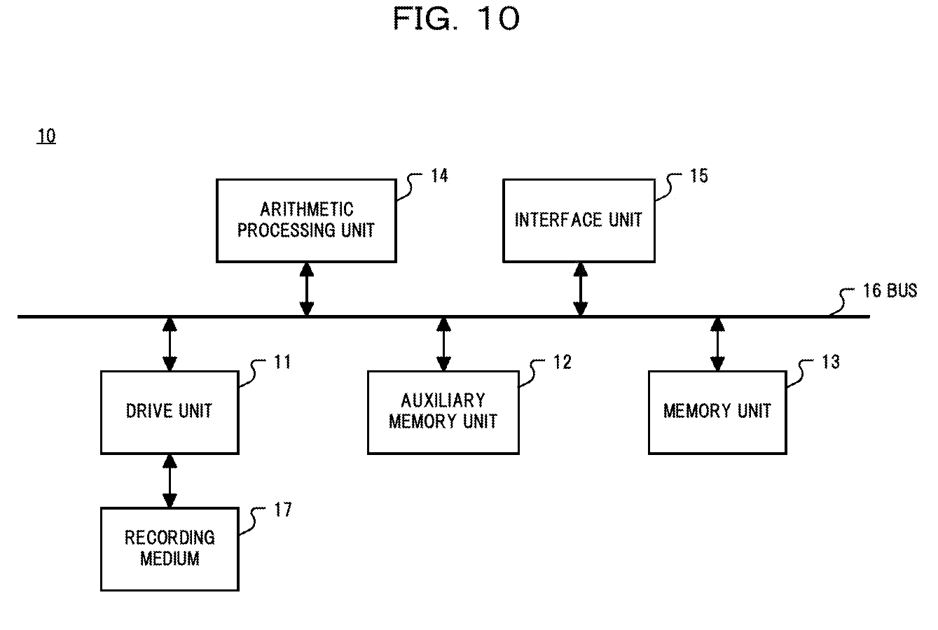

FIG. 10 illustrates an example of a hardware configuration of a computer that executes a hold error correction program according to any of the first to the third embodiments. As illustrated in FIG. 10, a computer 10 includes a drive unit 11, an auxiliary memory unit 12, a memory unit 13, an arithmetic processing unit (CPU) 14, and an interface unit 15 all interconnected by a bus 16.

The drive unit 11 is a device reading a recording medium 17. Setting the recording medium 17, which stores the program, on the drive unit 11 allows the program to be installed on the auxiliary memory unit 12 from the recording medium 17 via the drive unit 11. For example, the hold error correction program is recorded on the recording medium 17, for example, a CD-ROM or the like, and installation of the hold error correction program is completed by being read by the computer 10.

The auxiliary memory unit 12 is a device not only storing the installed program but also storing files, data, and so on. The memory unit 13 is a device reading and storing the program from the auxiliary memory unit 12 upon receipt of a program start instruction. The processing unit 14 is a device executing functions associated with the computer 10, based on the program stored in the memory 13. The interface unit 15 is a device connecting the computer 10 to a variety of networks, such as, the Internet, a local area network (LAN), an intranet, or the like. For example, the hold error correction program is stored in an external server connected via the network. It is also possible that the computer 10 loads and installs the program thereon.

As disclosed hereinabove, the best modes for carrying out the embodiments are disclosed. Note, however, that the disclosed embodiments are not limited to the embodiment disclosed above. A variety of modifications may be possible without departing from the spirit and the scope of the disclosed embodiments.

For example, the hold error correction device which achieves a hold error correction method may be provided by hardware, software, or a combination thereof. The hold error correction device is a hold error corrector which corrects the hold errors that occurred in the semiconductor integrated circuit. The hold error correction device includes an analyzer, a hold error information acquirer, a classifier, a grouping unit, and a determiner. The analyzer performs a hold timing analysis and a set-up timing analysis. With the analyses, whether or not there is a violation of a timing constraint defined in association with a set-up time and a hold time in the semiconductor integrated circuit is analyzed. The hold error information acquirer acquires hold error path start point information and hold error path end point information with respect to the hold error paths on which the hold errors have occurred based on each result supplied from the analyzer. The classifier classifies the hold error paths into either a correctable hold error path or an uncorrectable hold error path based on an output from the hold error information acquirer. Note, here, that the correctable hold error path is a path whose hold error is correctable, and the uncorrectable hold error path is a path whose hold error is not correctable. The grouping unit groups the correctable hold error paths classified by the classifier into groups, based on whether or not a start point and an end point of each of the correctable hold error paths coincide with each other. Finally, the determiner determines into which of the start point and the end point of the correctable hold error path a delay buffer is inserted, with respect to each of the groups of the correctable hold error paths that have been grouped by the grouping unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

What is claimed is:

1. A method of correcting a hold error in a semiconductor integrated circuit, the method comprising:
performing a hold timing analysis and a set-up timing analysis which analyze whether there is a violation of a timing constraint defined in association with a set-up time and a hold time in the semiconductor integrated circuit;
acquiring hold error path start point information that includes a set of a hold error amount at a start point of the hold error path and a minimum value of set-up margins for all data paths starting from the start point, and hold error path end point information that includes a set of a hold error amount at an end point of the hold error path and a minimum value of set-up margins for all data paths reaching the end point, with respect to a hold error path on which a hold error has occurred, based on a result from the hold timing analysis and a result from the set-up timing analysis,
classifying the hold error path into either a correctable hold error path whose hold error is correctable or an uncorrectable hold error path whose hold error is uncorrectable, based on the hold error path start point information and the hold error path end point information;
grouping the correctable hold error paths based on whether one of a start point and an end point of each of the correctable hold error paths coincides with each other; and
determining into which of the start point and the end point of the correctable hold error path a delay buffer is inserted with respect to each group of the grouped correctable hold error paths.

2. The method of correcting the hold error according to claim 1, wherein the set-up timing analysis is performed on a path which shares one of the start point and the end point with the path on which the hold error has occurred, based on the hold timing analysis.

3. The method of correcting the hold error according to claim 1, wherein the hold timing analysis and the set-up timing analysis are performed with respect to a plurality of operation modes of the integrated circuit.

4. The method of correcting the hold error according to any of claim 1, 2, or 3, wherein the hold error path is determined to be the correctable hold error path when equations “a×(a start point set-up margin value)−b×(a start point hold error value)>c” and “d×(an end point set-up margin value)−e×(an end point hold error value)>f” are satisfied, the equations being evaluation functions to which the hold error path start point information and the hold error path end point information are assigned.

5. The method of correcting the hold error according to any of claim 1, 2, or 3, wherein an insertion position of the delay buffer is determined so that a low or preferably minimum cost is achieved with respect to each group of the correctable hold error paths, by using a cost function in which the number of buffers, an amount of delays, an area of insertion, a consumption of power, the number of correctable hold error data paths, and an amount of processes incurred by a change in layout resulting from the buffer insertion are combined.

6. A recording medium capable of being read by a computer storing a program causing the computer to execute operations for correcting a hold error occurring in a semiconductor integrated circuit, the program comprising:
performing a hold timing analysis and a set-up timing analysis which analyze whether there is a violation of a timing constraint defined in association with a set-up time and a hold time in the semiconductor integrated circuit;
acquiring hold error path start point information that includes a set of a hold error amount at a start point of the hold error path and a minimum value of set-up margins for all data paths starting from the start point, and hold error path end point information that includes a set of a hold error amount at an end point of the hold error path and a minimum value of set-up margins for all data paths reaching the end point, with respect to a hold error path on which a hold error has occurred, based on a result from the hold timing analysis and a result from the set-up timing analysis;
classifying the hold error path into either a correctable hold error path whose hold error is correctable or an uncorrectable hold error path whose hold error is uncorrectable, based on the hold error path start point information and the hold error path end point information;
grouping the correctable hold error paths based on whether one of a start point and an end point of each of the correctable hold error paths coincides with each other; and
determining into which of the start point and the end point of the correctable hold error path a delay buffer is inserted with respect to each group of the grouped correctable hold error paths.

7. An apparatus for correcting a hold error occurring in a semiconductor integrated circuit, the apparatus comprising:
an analyzing unit which performs a hold timing analysis and a set-up timing analysis to analyze whether there is a violation of a timing constraint defined in association with a set-up time and a hold time in the semiconductor integrated circuit;
a hold error information acquiring unit which acquires hold error path start point information that includes a set of a hold error amount at a start point of the hold error path and a minimum value in set-up margins for all data paths starting from the start point, and hold error path end point information that includes a set of a hold error amount at an end point of the hold error path and a minimum value in set-up margins for all data paths reaching the end point, with respect to a hold error path on which a hold error has occurred, based on a result obtained by the analysis unit;
a classifying unit which classifies the hold error path into one of a correctable hold error path whose hold error is correctable and an uncorrectable hold error path whose hold error is uncorrectable, based on an output of the hold error information acquisition unit;
a grouping unit which groups the hold error paths, classified by the classification unit as the correctable hold error paths, based on whether one of a start point and an end point of each of the correctable hold error paths coincides with each other; and
a determining unit which determines into which of the start point and the end point of the correctable hold error paths a delay buffer is inserted with respect to each group of the correctable hold error paths grouped by the grouping unit.
